(19) United States
(12) Patent Application Publication
(10) Pub. No.: US 2007/0135070 A1
(43) Pub. Date: Jun. 14, 2007

(54) Extended Range Received Signal Strength Indicator Module

(76) Inventors: Tzu-Huan Chiu, Tai-Chung Hsien (TW); Yi-Jen Lin, Taipei City (TW); Yu-Hua Liu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,974

(22) Filed: Dec. 13, 2005

(51) Int. Cl. H04B 17/00

(52) U.S. Cl. 455/226.2; 455/134

(57) ABSTRACT

An extended range received signal strength indicator module includes input lines connected to a variable gain amplifier, which passes the amplified RF signal to a polyphase, which in turn passes the filtered signal to a series of RSSI stages. Each RSSI stage includes a log amplifier and outputs an amplified current to a current summer as well as to the next RSSI stage in the series. The current summer outputs the sum of the received currents to RSSI_OUT. An additional frequency filter and RSSI stage with inputs connected to the input lines before the variable gain amplifier that outputs the modified current to the current summer is also included. A control circuit switches the additional RSSI stage on or off as determined by a detection circuit that monitors the value of RSSI_OUT.

### BACKGROUND OF THE INVENTION

1. Field of the Invention

The present invention pertains to a Received Signal Strength Indicator (RSSI) module in a radio receiver, and more particularly to an RSSI module having an energy efficient, extended acceptable range of RF input power.

2. Description of the Prior Art

Radio receivers have a defined range of the strength of an RF signal with which they are capable of operating with acceptable error. The boundaries of this range are defined by Radio Signal Strength (RSS) values that are, of course, dependant upon the specific radio receiver being utilized. The received RF signal must be measured using a Received Signal Strength Indicator (RSSI) module in order to determine whether or not the received RF signal falls within the usable range. If the received RF signal is outside the useable range, adjustments must be made such as changing the channel or base station.

A conventional RSSI module 100 is depicted in FIG. 1 and comprises input lines A, an amplifier 115, and a frequency filter 120, which is followed by a series of RSSI stages 131-135. Each stage 131-134 comprises a filter and amplifier and outputs an amplified current to current summer 140 as well as to the next stage 132-135. The final stage in the series (135) also outputs an amplified current to the current summer 140. For example, stage 131 inputs the current from the frequency filter 120, amplifies it, and outputs the amplified current i1 to the current summer 140 and to stage 132. Stage 132 inputs the amplified current i1 from stage 131, amplifies it again, and outputs the twice amplified current i2 to the current summer 140 and to stage 133, etc. The current summer 140 does just what the name indicates and outputs the sum of the currents i1, i2, i3, i4, and i5 as RSSI_OUT and to ground. Obviously, the number of stages used in any specific device is subject to design considerations.

The problem with such a system is that it is easy for any or all of the stages to become saturated if the originally received RF signal is too strong. When saturation occurs, the curve of the outputted RSSI_OUT begins to flatten as can be seen at higher input powers in FIG. 2. This flattening of the RSSI curve renders the RSSI_OUT worthless as an accurate indication of signal.

### SUMMARY OF THE INVENTION

It is therefore a primary objective of the claimed invention to provide a method and device for extending the useful RSS range to accommodate a stronger RF input signal.

To extend the useful RSS range, the claimed invention RSSI module includes input lines connected to a variable gain amplifier, which passes the amplified RF signal to a polyphase filter, which in turn passes the filtered signal to a series of RSSI stages. Each RSSI stage includes a log amplifier and outputs an amplified current to a current summer as well as to the next RSSI stage in the series. The current summer outputs the sum of the received currents to RSSI_OUT and to ground.

The claimed invention also includes an additional RSSI stage with inputs connected to the input lines before the variable gain amplifier and outputs the modified current directly to the current summer. A frequency filter is placed between the input lines and the additional RSSI stage to filter out unwanted signal. A control circuit switches the additional RSSI stage on or off as determined by a detection circuit that monitors the value of RSSI_OUT. When the value of RSSI_OUT falls within the acceptable range, the control circuit turns the additional RSSI stage off. When the inputted RF signal is too strong so that the value of RSSI_OUT does not fall within the acceptable range, the control circuit turns the additional RSSI stage on so that current outputted by the additional RSSI stage is inputted to the current summer.

The introduction of the additional RSSI stage and associated frequency filter effectively extend the range of the RSSI curve, permitting a stronger input signal to be utilized while remaining within acceptable error limits. The addition of the detection circuit and the control circuit to switch the additional RSSI stage and filter on or off as needed reduces overall power consumption while retaining the benefits of the claimed invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an RSSI module according to the prior art.

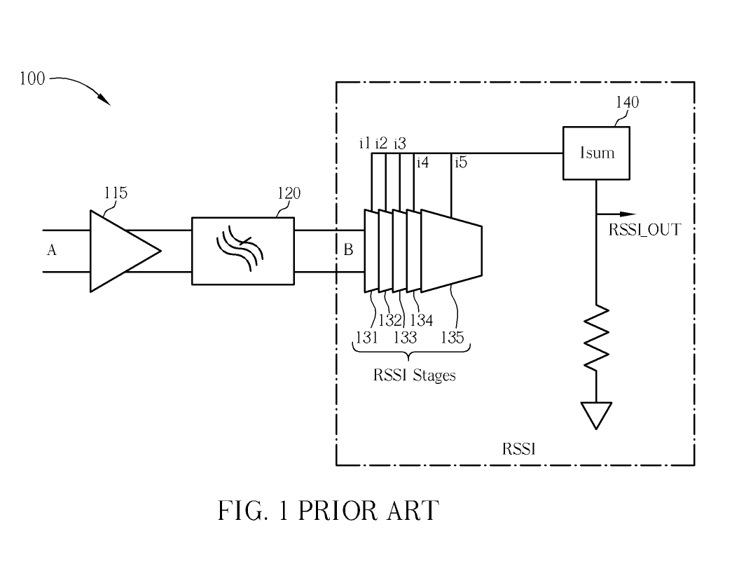

FIG. 2 is an example graph of RSSI values produced by the RSSI module of FIG. 1.

FIG. 3 is an RSSI module according to the present invention.

FIG. 4 is a graph of RSSI values produced by the RSSI module of FIG. 3.

### DETAILED DESCRIPTION

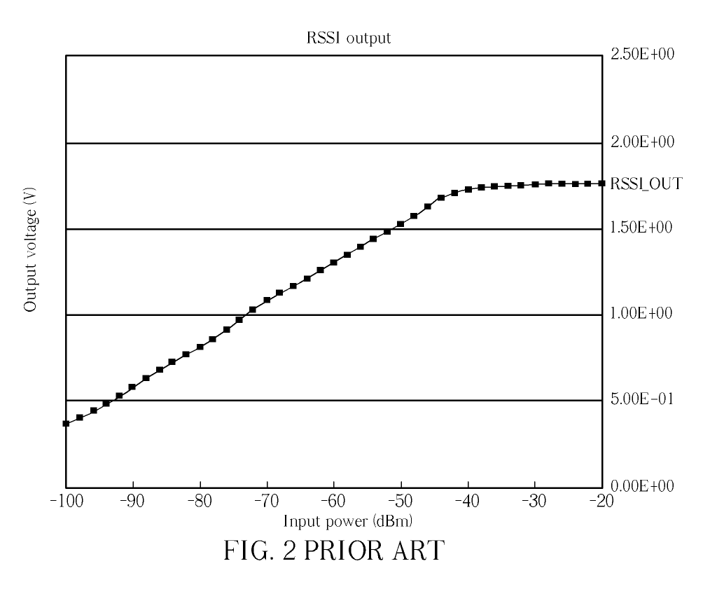

The RSSI curve in FIG. 2 has a limited RSS range because of the number of stages used, the gain of each stage, and the currents that each stage can have. The present invention discloses an RSSI module capable of extending the upper portion of the RSS range further to accommodate a higher input power range while keeping cost considerations and performance at lower input power levels in mind.

When the input power reaches the upper limit of the RSS range, the RSSI curve begins to flatten due one of two reasons. The first reason is that the waveform from a stage before the RSSI value is calculated may have reached its saturation limit. The second reason is that currents from all stages reach the maximum value.

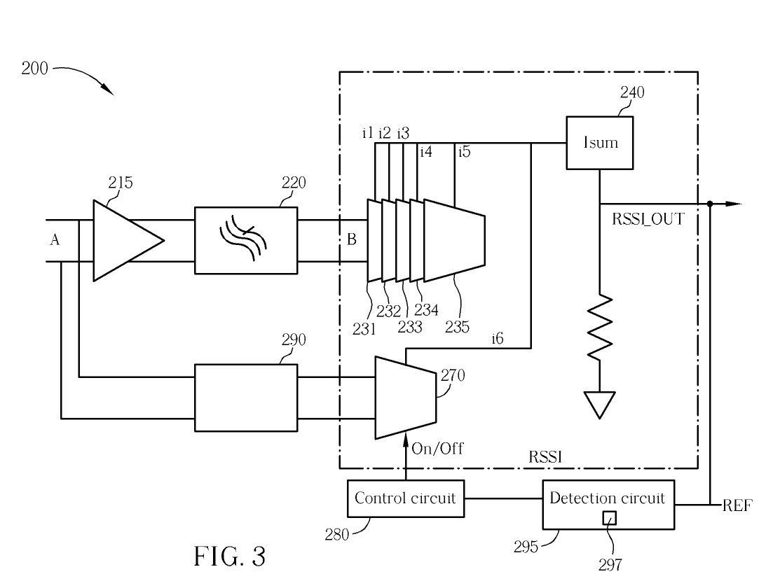

In order to get around these problems, the present invention adds one more RSSI stage 270, a control circuit 280, and a detection circuit 295 as can be seen in FIG. 3. As depicted in FIG. 3, the present invention RSSI module 200 also comprises input lines A, a variable gain amplifier (VGA) 215, and a polyphase filter 220 (preferably 0 dB) which is followed by a series of RSSI stages 231-235. As in the conventional RSSI module, each RSSI stage 231-234 comprises a filter and log amplifier and outputs an amplified current to current summer 240 as well as to the next stage 232-235. The final RSSI stage in the series (235) also outputs an amplified current to the current summer 240. The current summer 240 outputs the sum of the currents i1, i2, i3, i4, and i5 to RSSI_OUT and to ground.

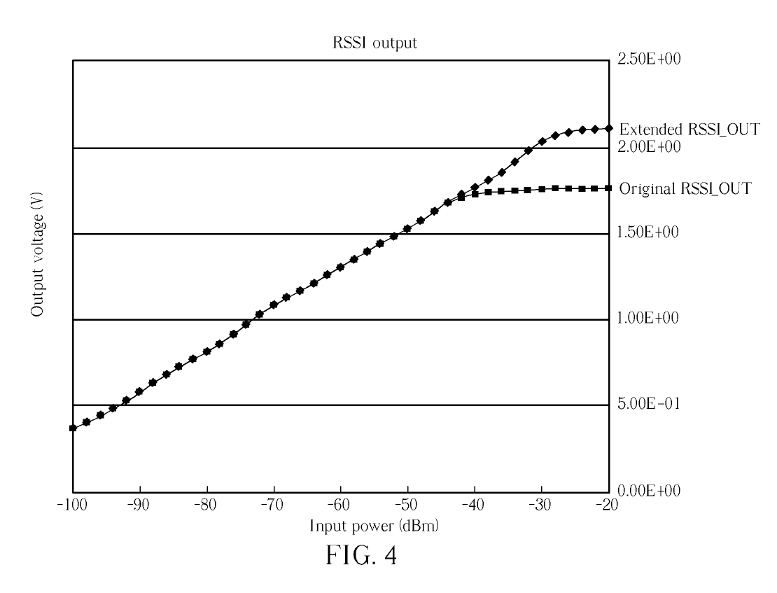

The polyphase filter 220 has a predetermined gain (preferably 24 dB) and when saturated, cannot correctly pass the received signal to the RSSI stages 231-235. To get around this problem, the present invention also comprises the additional RSSI stage 270 in parallel with the RSSI stages 231-235, with inputs connected to the input lines A before the VGA and outputs the modified current i6 to the current summer 240. A control circuit 280 switches the RSSI stage 270 on or off as determined by the detection circuit 295. An additional low pass (log amplifier) filter 290 should be placed between the RSSI stage 270 and the input lines A for filtering the RF signal before it reaches the RSSI stage 270. The filter 290 is needed because the RF signal is tapped before the polyphase filter 220 and blocking signals from adjacent channels may be present in the unfiltered signal and interfere with signal detection. The filter 290 works as a log amplifier similar to those in the other RSSI stages 231-235 to provide the current needed to extend the RSSI curve as can be seen in FIG. 4.

A detection circuit 295 monitors the value of RSSI_OUT and informs the control circuit 280 whether or not the RSSI_OUT value falls within the acceptable range. When the value of RSSI_OUT falls within the acceptable range, the control circuit turns the RSSI stage 270 off so that no i6 current reaches the current summer 240. When the inputted RF signal is too strong so that the value of RSSI_OUT does not fall within the acceptable range, the control circuit turns the RSSI stage 270 on so that the current i6 is inputted to the current summer 240.

During monitoring of the RSSI_OUT signal, the detection circuit 295 utilizes the point where the value of the RSSI_OUT curve begins to flatten. The specific critical point can be predetermined via calculation or experimentation as desired. A comparator 297 is used in one embodiment of the present invention where the RSSI_OUT signal is compared with a reference signal (REF) to make this determination. When the determination is made that the RSSI_OUT value is above the critical point where the RSSI_OUT curve will begin to flatten, the detection circuit 295 informs the control circuit 280 to turn on the RSSI stage 270 and low pass filter 290 to extend the RSSI range appropriately. When the determination is made that the value of RSSI_OUT is not above the critical point, the detection circuit informs the control circuit 280 to turn off the RSSI stage 270 and low pass filter 290. The control circuit may turn the RSSI stage 270 and low pass filter 290 on or off with the use of a one-bit enable signal or alternatively a single switch could be utilized to disconnect them from the current summer 240. Both methods are intended to fall within the scope of the appended claims.

It should be mentioned that one embodiment of the present invention is similar to FIG. 3, except that no control circuit 280 and detection circuit 295 are used and the filter 290 and RSSI stage 270 are always turned on. It is preferred, however, to include the control circuit 280 and the detection circuit 295 and turn on the filter 290 and RSSI stage 270 only when needed to save power.

The present invention increases the acceptable range of RF input power in an RSSI module in a radio receiver by introducing an additional RSSI stage and associated filter that taps directly off of the inputted RF signal. A detection circuit monitors RSSI_OUT to determine if the RF signal falls within an acceptable normal power range. When the strength of the RF signal exceeds the acceptable power range, the detection circuit informs the control circuit to switch on the additional RSSI stage and associated filter to temporarily extend the upper limits of the acceptable power range. When the strength of the RF signal no longer exceeds the acceptable normal power range, the detection circuit informs the control circuit to switch off the additional RSSI stage and associated filter to save power. The present invention offers the distinct advantage of allowing the RSSI module to continue to operate within acceptable error tolerances by efficiently and temporarily extending the upper limit of acceptable input RF power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An extended range signal strength indicator (RSSI) module for use in a radio receiver, the RSSI module comprising:
a serially connected first RSSI circuit connecting an RF input line with a current summer, the first RSSI circuit comprising a first amplifier, a first frequency filter, and a plurality of RSSI stages;
a serially connected second RSSI circuit connecting the RF input line with the current summer in parallel with the first RSSI circuit, the second RSSI circuit comprising a second frequency filter and an additional RSSI stage; and
a control circuit connected to the second RSSI circuit for electrically connecting and disconnecting the second RSSI circuit from the current summer according to the strength of a received RF signal.

2. The RSSI module of claim 1 wherein when output of the current summer exceeds a predetermined value, the control circuit electrically connects the second RSSI circuit to the current summer, and when the output of the current summer does not exceed the predetermined value, the control circuit electrically disconnects the second RSSI circuit from the current summer.

3. The RSSI module of claim 2 further comprising a detection circuit connected to the output of the current summer for determining if the output of the current summer exceeds the predetermined value.

4. The RSSI module of claim 3 wherein the detection circuit is connected to the control circuit for informing the control circuit whether or not the output of the current summer exceeds the predetermined value.

5. The RSSI module of claim 4 wherein the detection circuit comprises a comparator having inputs connected to the output of the current summer and to a reference voltage.

6. The RSSI module of claim 5 wherein the output of the comparator is electrically connected to the control circuit for informing the control circuit whether or not the output of the current summer exceeds the predetermined value.

7. The RSSI module of claim 4 wherein the first frequency filter is a polyphase filter.

8. The RSSI module of claim 7 wherein the first amplifier is a variable gain amplifier.

9. The RSSI module of claim 4 wherein each RSSI stage comprises a log amplifier.

10. A method of extended a range of RF input power in a Received Signal Strength Indicator (RSSI) module in a radio receiver, the method comprising:
connecting a plurality of serially connected RSSI stages between an RF input line and a current summer, the current summer receiving an output signal from each of the plurality of RSSI stages;
connecting an additional RSSI stage between the RF input line and the current summer in parallel with the plurality of serially connected RSSI stages;
turning on the additional RSSI stage when output of the current summer exceeds a predetermined value; and
turning off the additional RSSI stage when output of the current summer does not exceed the predetermined value.

11. The method of claim 10 further comprising amplifying and frequency filtering a received RF signal between the RF input line and the plurality of serially connected RSSI stages.

12. The method of claim 11 further comprising frequency filtering the received RF signal between the RF input line and the additional RSSI stage.

13. The method of claim 12 further comprising comparing the output of the current summer with a reference voltage to determine if the output of the current summer exceeds the predetermined value.

14. An extended range signal strength indicator (RSSI) module for use in a radio receiver, the RSSI module comprising:
a plurality of serially connected RSSI stages connecting an RF input line with a current summer; and
an additional RSSI stage connecting the RF input line with the current summer in parallel with the purality of RSSI stages.

15. The RSSI module of claim 14 further comprising a control circuit connected to the additional RSSI stage for turning on and off the additional RSSI stage according to the strength of a received RF signal.

16. The RSSI module of claim 15 wherein when output of the current summer exceeds a predetermined value, the control circuit turns on the additional RSSI stage, and when the output of the current summer does not exceed the predetermined value, the control circuit turns off the additional RSSI stage.

17. The RSSI module of claim 16 further comprising a detection circuit connected to the output of the current summer, to the control circuit, and to a reference voltage for determining if the output of the current summer exceeds the predetermined value.

18. The RSSI module of claim 17 wherein the detection circuit comprises a comparator having inputs connected to the output of the current summer and to the reference voltage and the output of the comparator is electrically connected to the control circuit for informing the control circuit whether or not the output of the current summer exceeds the predetermined value.

19. The RSSI module of claim 18 further comprising a polyphase filter connected between the RF input line and the plurality of RSSI stages.

20. The RSSI module of claim 19 further comprising a variable gain amplifier connected between the RF input line and the polyphase filter.
